(19) United States
(12) Patent Application Publication
(10) Pub. No.: US 2025/0137277 A1
(43) Pub. Date: May 1, 2025

(54) POLE AND POLE UNIT

(71) Applicant: NEC Corporation, Minato-ku, Tokyo (JP)

(72) Inventors: Takashi TONEGAWA, Tokyo (JP); Tetsuya TAKAKI, Tokyo (JP); Masaya AMANO, Tokyo (JP); Yuji SATO, Tokyo (JP); Kazuki OGATA, Tokyo (JP)

(73) Assignee: NEC Corporation, Minato-ku, Tokyo (JP)

(21) Appl. No.: 18/835,759

(22) PCT Filed: Feb. 9, 2022
(86) PCT No.: PCT/JP2022/005146

§ 371 Date: Aug. 5, 2024

(51) Int. Cl. E04H 12/00; E04H 12/34; G08G 1/095

(52) U.S. Cl. CPC E04H 12/003; E04H 12/34; G08G 1/095

(57) ABSTRACT

There is provided a pole enabling devices having various sizes to be mounted therein while curbing having a cluttered appearance. A pole (1) includes a shelf board (3) configured to partition an internal space (2) of the pole (1); a door (132, 161) configured to close each of subspaces (4) partitioned by the shelf board (3). The door (132, 161) has a structure in which a size of a surface of the door (132, 161) is variable, each of the subspaces (4) has a size which is changed by changing a position of the shelf board (3), each of the subspaces (4) is closed by changing a size of a surface of the door (132, 161), and each of the subspaces (4) accommodates a device (90) having a predetermined function.

### TECHNICAL FIELD

The present disclosure relates to a pole and a pole unit.

### BACKGROUND ART

As the related art, Patent Literature 1 discloses a pole to which a device can be attached. The pole disclosed in Patent Literature 1 includes a cylindrical support pillar and one or more coupling poles. The coupling pole includes a cylindrical body. The cylindrical body includes a first connection part provided at one end thereof in the longitudinal direction, a second connection part provided at the other end thereof in the longitudinal direction, and a device attachment part to which a device is attached. The first connection part of each of the coupling poles is configured to be connectable to the second connection part of another coupling pole. The support pillar includes a fixed part provided at one end thereof in the longitudinal direction and a third connection part provided at the other end thereof in the longitudinal direction. The third connection part is configured to be connectable to the first connection part or the second connection part of the coupling pole.

In Patent Literature 1, the fixed part of the support pillar includes a base plate. The base plate is fixed to a foundation provided on the ground using a fixing bolt. For example, the second connection part of the coupling pole is connected to the third connection part of the support pillar, and the coupling pole is connected onto the support pillar. On the coupling pole connected to the support pillar, any number of coupling poles may be connected by connecting the first connection part of one coupling pole to the second connection part of another coupling pole. A device such as a lighting fixture, a security camera, a speaker, or an automatic flashing device is attached to the device attachment part of each coupling pole.

### CITATION LIST

### Patent Literature

Patent Literature 1: Japanese Unexamined Patent Application Publication No. 2019-190002

### SUMMARY OF INVENTION

### Technical Problem

In Patent Literature 1, the coupling pole includes the device attachment part, and a device attached to the device attachment part of each coupling pole can be freely changed.

However, according to Patent Literature 1, the device is externally attached to the body of the coupling pole. According to Patent Literature 1, as the number of devices attached to the body of the coupling pole increases, it starts to have a cluttered appearance. Further, in a case where the pole enables various devices to be mounted, it is preferable that the pole enable the devices to be mounted regardless of sizes of the devices.

In view of the above-described circumstances, an object of the present disclosure is to provide a pole and a pole unit which enable devices having various sizes to be mounted in the pole while curbing having a cluttered appearance.

### Solution to Problem

To achieve the above object, the present disclosure provides a pole as a first example aspect.

This pole includes:
a shelf board configured to partition an internal space of the pole; and
a door configured to close each of subspaces partitioned by the shelf board.

The door has a structure in which a size of a surface of the door is variable,
each of the subspaces has a size which is changed by changing a position of the shelf board,
each of the subspaces is closed by changing a size of a surface of the door, and
each of the subspaces accommodates a device having a predetermined function.

Further, the present disclosure provides a pole unit as a second example aspect.

This pole unit includes:
a shelf board configured to partition an internal space of the pole unit; and
a door configured to close each of subspaces partitioned by the shelf board.

The door has a structure in which a size of a surface of the door is variable,
each of the subspaces has a size which is changed by changing a position of the shelf board,
each of the subspaces is closed by changing a size of a surface of the door,
each of the subspaces accommodates a device having a predetermined function, and
the pole unit is coupled to another pole unit in a row to be used as one pole.

### Advantageous Effects of Invention

According to the pole or the pole unit of the present disclosure, the pole enables devices having various sizes to be mounted therein while curbing having a cluttered appearance.

### BRIEF DESCRIPTION OF DRAWINGS

FIG. 1 is a schematic cross-sectional view of a pole according to the present disclosure.

FIG. 2A is a front view showing a multifunctional pole according to an example embodiment of the present disclosure.

FIG. 2B is an exploded perspective view showing a multifunctional pole according to an example embodiment of the present disclosure.

FIG. 3 is an exploded perspective view showing a configuration example of a unit for a traffic signal.

FIG. 4 is a perspective view showing a unit that may be used in the multifunctional pole.

FIG. 5 is a schematic view showing an example of a configuration of a unit for accommodating a plurality of devices in an internal space.

FIG. 6 is a schematic view showing an example of a configuration of a unit for accommodating a plurality of devices in an internal space.

FIG. 7 is a perspective view showing a configuration example of a shelf board having a shutter.

FIG. 8 is a schematic view showing an example of a configuration of a unit for accommodating a plurality of devices in an internal space.

FIG. 9 is a schematic view showing an example of a configuration of a unit for accommodating a plurality of devices in an internal space.

FIG. 10 is a schematic view showing an example of a configuration of a unit for accommodating a plurality of devices in an internal space.

FIG. 11 is a schematic view showing an example of a configuration for realizing coupling of unit doors.

FIG. 12 is a front view showing an example of a multifunctional pole according to a modified example.

FIG. 13 is a front view showing an example of a multifunctional pole according to another modified example.

FIG. 14 is a block diagram showing an example of a configuration of a control unit.

### EXAMPLE EMBODIMENT

Prior to describing example embodiments of the present disclosure, an outline of the present disclosure will be described.

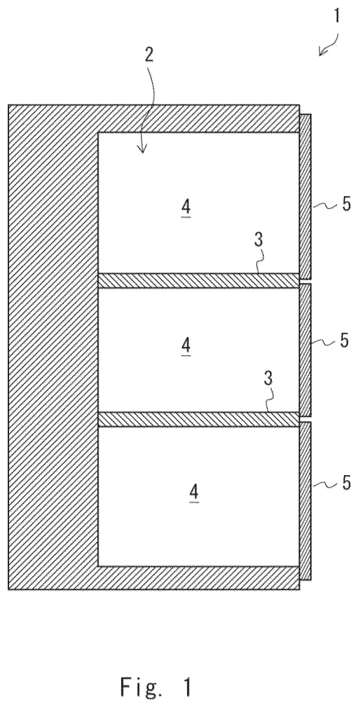

FIG. 1 is a schematic cross-sectional view of a pole according to the present disclosure. A pole 1 has a space therein. That is, the pole 1 has an internal space 2. The pole 1 is capable of accommodating various devices in the internal space 2. In other words, the pole 1 itself is used as a housing for accommodating devices.

As shown in FIG. 1, the pole 1 includes at least one shelf board 3 that partitions the internal space 2 of the pole 1, and a door 5 that closes each of subspaces 4 partitioned by the shelf board 3. Here, the subspace 4 is a subspace of the internal space 2 and is a space divided by the shelf board 3. In the example shown in FIG. 1, the internal space 2 is divided into three subspaces 4 by the two shelf boards 3. Although two shelf boards 3 are used in FIG. 1, this is merely an example, and the number of shelf boards 3 is not limited to two. That is, the number of subspaces 4 is not limited to three.

A position of the shelf board 3 can be changed, and a size of the subspace is changed by changing the position of the shelf board 3. Note that the position of the shelf board 3 refers to the position of the shelf board 3 in an arrangement direction (vertical direction) of the subspaces 4. In the example shown in FIG. 1, by changing a height at which the upper shelf board 3 of two shelf boards 3 is mounted, sizes of the uppermost subspace 4 and the middle subspace 4, that is, vertical lengths of these subspaces 4 are changed. A device having a predetermined function is accommodated in the subspace 4. It is possible to set the subspace 4 corresponding to a size of a device to be accommodated, by changing the position of the shelf board 3.

Further, the door 5 has a structure in which a size of a surface of the door 5 is variable. Specifically, for example, as will be described below, such a structure may be realized by a shutter, or such a structure may be realized by a plurality of unit doors which can be coupled to each other. Each subspace 4 is closed by changing a size of a surface of the door 5. That is, the size of the surface of the door 5 is changed according to the set size of the subspace 4. Therefore, it is possible to appropriately close each space in which the device is accommodated.

As described above, the pole 1 includes the shelf boards 3 having respective positions that can be changed and the doors 5 having sizes that can be changed, and devices are accommodated in the respective subspaces 4 divided by the shelf boards 3. Therefore, a size of the subspace 4 (that is, accommodation space) can be changed according to the size of the device, and the subspace 4 is appropriately closed. Therefore, it is possible to prevent the pole from having a cluttered appearance as compared with a case where a plurality of external devices are attached to the pole, and it is possible to appropriately accommodate the devices according to the sizes of the devices. Therefore, according to the pole 1, the pole enables devices having various sizes to be mounted therein while curbing having the cluttered appearance of the pole. For example, when the above pole is installed in a park or the like, it is possible to prevent the pole from spoiling the landscape due to the pole not being in harmony with the landscape in a place where the pole is installed.

Note that the pole 1 may be configured as one pole by coupling a plurality of units as will be described below, or may be configured as one structural member (one unit) instead of such a plurality of units.

The example embodiments according to the present disclosure will be described hereinafter in detail with reference to the drawings. Note that, for the clarification of the description, the following descriptions and the drawings are partially omitted and simplified as appropriate. Further, the same elements and similar elements are denoted by the same reference symbols throughout the drawings, and redundant descriptions are omitted as necessary.

### First Example Embodiment

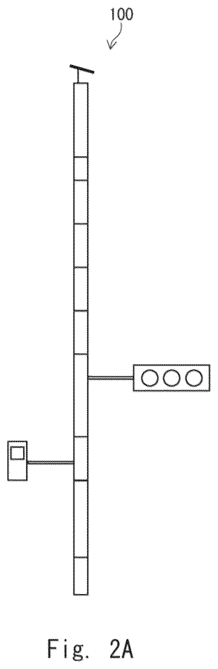

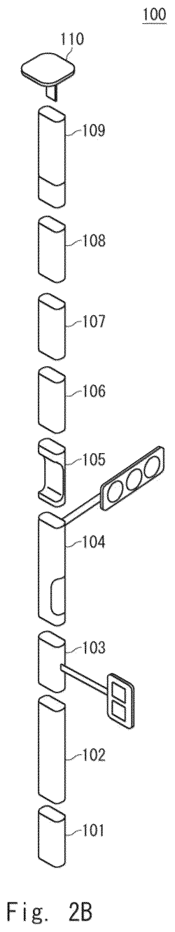

Each of FIGS. 2A and 2B shows a multifunctional pole 100 according to an example embodiment of the present disclosure. In the example embodiment, the multifunctional pole 100 constitutes a traffic signal. FIG. 2A is a front view of the multifunctional pole 100 as the traffic signal from the front thereof, while FIG. 2B is an exploded perspective view of the multifunctional pole 100 as the traffic signal in an oblique direction. The multifunctional pole 100 includes a plurality of units 101 to 109 coupled to each other. Each of the units 101 to 109 may also be referred to as a pole unit, a sub-pole, a unit, or an assembly (ASSY).

The unit 101 is, for example, a unit constituting a shared unit. That is, the unit 101 has a device shared for various functions of the multifunctional pole 100. The unit 101 includes therein devices such as a power supply apparatus and a network apparatus. The power supply apparatus supplies power to devices mounted in the units 101 to 109. The network apparatus is connected to an external network. The devices mounted in the units 102 to 109 may be configured so that the units can communicate with the external network through the network apparatus of the unit 101. In this manner, the unit 101 accommodates one or more devices in the internal space of the unit 101. Note that the unit 101 may accommodate one or more devices for the same function in the internal space, or may accommodate a plurality of devices for a plurality of different functions in the internal space. The unit 101 may, for example, be at least partially embedded in the ground. However, it is not particularly limited thereto. Alternatively, the unit 101 may be coupled to a foundation disposed in the ground using a fastening bolt and the like. The unit 101 may be coupled to a support pillar embedded in the ground.

The unit 102 is, for example, a unit having a function of digital signage. The unit 102 includes, for example, a display and a control unit (controller). The unit 102 may include a speaker and a microphone. The unit 102 may further include an edge computer (Multi-access/Mobile Edge Computing (MEC) server). The unit 102 accommodates one or more devices in the internal space of the unit 102. Note that, in the unit 102, one or more devices for the same function (for example, the function of the digital signage) may be accommodated in the internal space, or a plurality of devices for a plurality of different functions may be accommodated in the internal space.

The units 103 and 104 are units each having a function of a traffic signal. The unit 103 is a unit having a function of a traffic signal for pedestrians. The unit 104 is a unit having a function of a traffic signal for vehicles. A configuration of the unit 103 having the function of a traffic signal for pedestrians is similar to a configuration of the unit 104 except that a traffic signal lighting device is used for pedestrians. Therefore, the unit 104 will be described, and the description of the unit 103 will be omitted.

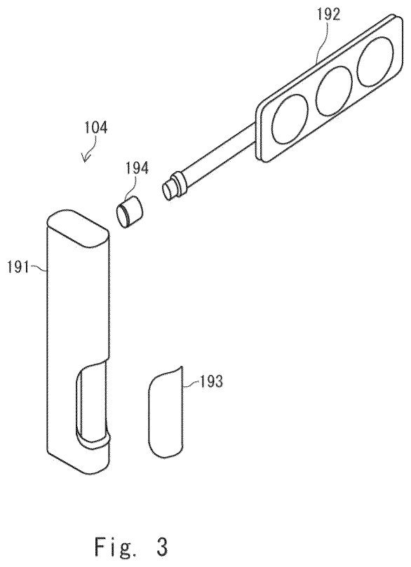

FIG. 3 shows a configuration example of the unit 104. In the unit 104, a traffic signal lighting device 192 is attached to a body 191. The traffic signal lighting device 192 includes green (blue), yellow, and red lamps. The body 191 includes an attachment to which an attachment tool 194 is attached. An arm of the traffic signal lighting device 192 is attached to the body 191 with the attachment tool 194 interposed therebetween. The body 191 may include therein a camera that is used to control the traffic signal lighting device. A transparent cover 193 for protecting the camera may be attached to the body 191. The unit 103 accommodates one or more devices in an internal space of the unit 103. Note that, in the unit 103, one or more devices for the same function (for example, the function of the traffic signal) may be accommodated in the internal space, or a plurality of devices for a plurality of different functions may be accommodated in the internal space.

The unit 104 may include a control device for controlling a signal lighting device in the internal space (inside the body 191) of the unit 104, the control device controlling the traffic signal lighting device 192. Note that this control device is not necessarily disposed in the unit 104, and may be disposed in another unit. Further, a signal lighting device control circuit is not necessarily disposed in one of units of the multifunctional pole 100. For example, the signal lighting device control circuit may be disposed outside the multifunctional pole 100. In this case, the signal lighting device control circuit may communicate with the unit 104 through a network and control the traffic signal lighting device 192 through the network.

The unit 105 is a unit having a function of a security camera. The unit 105 includes, for example, a camera that captures an image of an area near the multifunctional pole 100 and a camera control circuit. The unit 105 accommodates one or more devices in an internal space of the unit 105. Note that, in the unit 105, one or more devices for the same function (for example, the function of the security camera) may be accommodated in the internal space, or a plurality of devices for a plurality of different functions may be accommodated in the internal space.

The units 106 to 108 are units for adjusting a height or a length of the pole. Therefore, the units 106 to 108 may not accommodate the devices, but may accommodate one or more devices as with other units.

The unit 109 is a unit having a function of a base station. The unit 109 may have a function of a public WiFi (registered trademark) base station, or may be a unit having a function of a 5th Generation (5G) antenna base station. Therefore, the unit 109 may have, for example, a radio communication device (transceiver). Note that a communication system of a radio communication function included in the multifunctional pole 100 is not limited to 5G and public WiFi. The multifunctional pole 100 may have a unit including a radio communication device of a communication system such as Multi-Channel Access (MCA) Advance or Cellular V2X (Vehicle to X) (C-V2X). Further, the radio communication is not limited to 5G, and may instead be radio communication conforming to a next generation communication standard. The unit 109 accommodates one or more devices in an internal space of the unit 109. Note that the unit 109 may accommodate one or more devices for the same function (for example, a function of a base station in one communication system) in the internal space. Further, the unit 109 may accommodate a plurality of devices for a plurality of different functions (for example, functions of a plurality of base stations for a plurality of different communication systems) in the internal space.

In the multifunctional pole 100, a device that generates power from renewable energy, for example, a solar panel 110, is attached onto the unit 109.

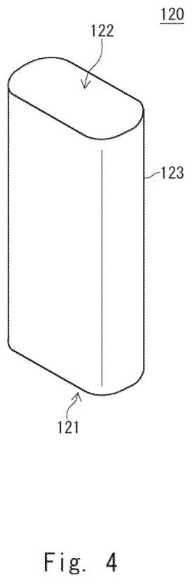

FIG. 4 shows a unit that may be used as the units 101 to 109. Hereinafter, when these units are referred to without being particularly distinguished, these units are referred to as units 120. A unit 120 includes a cylindrical body 123. The body 123 is formed of a material such as metal. The body 123 may be formed of various types of materials depending on the strength required for the unit and the weight allowed for the unit. For example, a unit that is expected to be installed at a high position in the multifunctional pole 100 may be formed of a light material such as carbon fiber.

The unit 120 may include, inside the body 123, a device for providing a predetermined function. In particular, in the present example embodiment, at least one of the units 120 has a configuration for accommodating a plurality of devices in the internal space. Note that details of such a configuration will be described below. The cross-sectional shape of the unit 120 in a plane perpendicular to the longitudinal direction may be elliptical or oblong. However, it is not limited to a particular shape. When the cross-sectional shape is elliptical or oblong, a device can be accommodated more efficiently than when the cross-sectional shape is circular. Further, an impression of the appearance can be improved. Lengths of the respective units (lengths of the pole in the longitudinal direction) may be different from each other or the same as each other.

The unit 120 includes a first connection part 121 at one end thereof in the longitudinal direction and a second connection part 122 at the other end thereof in the longitudinal direction. A plurality of units may be coupled by connecting the first connection part 121 of one unit (a first unit) 120 to the second connection part 122 of another unit (a second unit) 120.

The first unit (its first connection part) may be directly connected to the second unit (its second connection part). Alternatively, the first connection part may be connected to the second connection part with a connection member therebetween, the connection member being provided for connecting the connection parts to each other.

Note that the order of the units 101 to 109 shown in FIG. 2B is an example, and the order of the units in the multifunctional pole 100 is not limited to a particular order. Each of the units includes the first connection part 121 and the second connection part 122, and an arrangement order of the units in the multifunctional pole 100 can be freely changed. Further, in the multifunctional pole 100, the unit disposed at the lowest position only needs to have the second connection part 122 and may not have the first connection part 121.

In the present example embodiment, a pole of the multifunctional pole 100 is formed by appropriately combining the plurality of units 101 to 109 with each other. Each of the units has a predetermined function, and various types of functions can be added to the multifunctional pole 100 by appropriately selecting units to be used as the pole of the multifunctional pole 100. In the present example embodiment, the units 101 to 109 that form the pole have functions provided by the multifunctional pole 100. Therefore, as compared to a case where various types of devices are externally attached to the pole, the multifunctional pole 100 can prevent a cluttered appearance.

Next, in the present example embodiment, a configuration for accommodating a plurality of devices in the internal space of the unit 120 will specifically be described. Note that a configuration of the unit 120 to be described below may be employed in all of the units 101 to 109 described above, or may be employed in only some of the units.

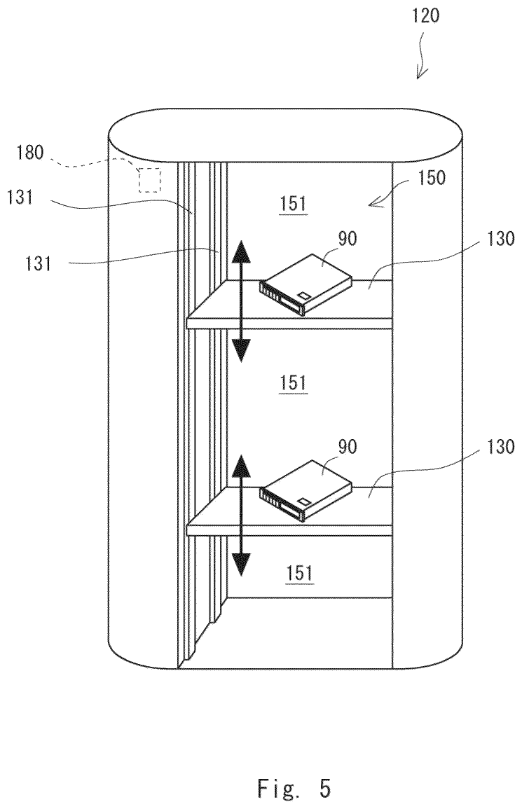

FIG. 5 is a schematic view showing an example of a configuration of the unit 120 for accommodating a plurality of devices 90 in an internal space 150. In FIG. 5, a shutter 132 and an outer door 140, which will be described below, are omitted for an easy understanding of an internal structure of the unit 120.

As shown in FIG. 5, the unit 120 has a space therein. That is, the unit 120 has an internal space 150. The unit 120 is capable of accommodating the various devices 90 in the internal space 150. In other words, the unit 120 is used as a housing that accommodates the devices 90. As shown in FIG. 5, the unit 120 includes at least one shelf board 130 that partitions the internal space 150. The shelf board 130 is provided to partition the internal space 150. Therefore, the shelf board 130 is present, and thereby the internal space 150 is divided into a plurality of subspaces 151. In the example shown in FIG. 5, the unit 120 includes two shelf boards 130, and the internal space 150 is divided into three subspaces 151. Although two shelf boards 130 are used in FIG. 5, this is merely an example, and the number of shelf boards 130 is not limited to two. That is, the number of subspaces 151 is not limited to three. Hence, the unit 120 may have at least one shelf board 130.

A position of the shelf board 130 (a height at which the shelf board 130 is installed) can be changed, and a size of the subspace 151 is changed by changing the position of the shelf board 130. Specifically, each shelf board 130 is disposed to form a horizontal surface, and the shelf board 130 moves in an up-down direction (vertical direction) along rails 131 provided on both sides of the internal space 150. That is, in the configuration example shown in the drawing, the shelf board 130 is supported by the rails 131 provided on both sides of the internal space 150, and supporting positions thereof can be changed. In FIG. 5, two rails 131 provided on one side of the shelf board 130 are shown, and rails are similarly present on the other side of the shelf board 130. Here, a configuration using the rails is shown as an example, and any other structure capable of supporting the shelf board 130 may be used. The device 90 having a predetermined function is accommodated in the subspace 151. Hence, it is possible to set the subspace 151 corresponding to a size of the device 90 to be accommodated, by changing a position of the shelf board 130. For example, the shelf board 130 is disposed at any position of a plurality of predetermined positions set at predetermined intervals in a movement direction of the shelf board 130, and the shelf board 130 may be disposed at any position.

Note that the position of the shelf board 130 may be changed by the work of a user such as a manager or may be automatically changed. In a case where the position of the shelf board 130 is automatically changed, for example, the multifunctional pole 100 may have a control unit 180 that controls an operation of the unit 120 related to the subspaces 151. Note that, in the example shown in FIG. 5, the control unit 180 is provided at a place inside the unit 120 other than the internal space 150, but may be provided in the internal space 150. Further, the control unit 180 may be provided in another unit. The control unit 180 is a control circuit that controls the operation of the unit 120 related to the subspaces 151, and outputs a control signal to, for example, an actuator that moves the position of the shelf board 130 along the rails 131. Note that the control unit 180 may perform control in accordance with a user's instruction input via a user interface device provided at any position (for example, the unit 101 constituting the shared unit) in the multifunctional pole 100. Further, the control unit 180 may perform control in accordance with an instruction transmitted from an apparatus outside the multifunctional pole 100.

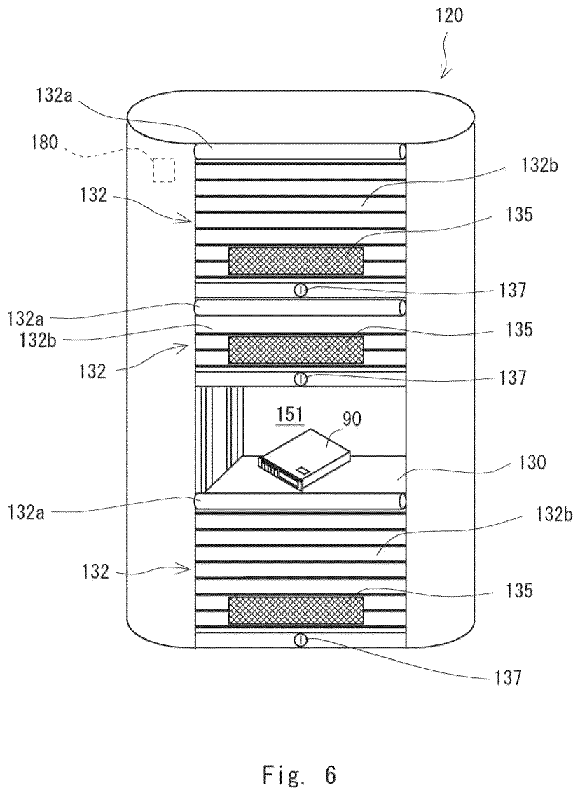

The unit 120 may further include a door that closes the subspace 151 partitioned by the shelf board 130. As described above, the size of the subspace 151 is variable. Therefore, the door for closing the subspace 151 has a structure in which a size of a surface covering the subspace 151 is variable. In the present example embodiment, such a structure is realized by using the shutter 132 as shown in FIG. 6. FIG. 6 is a schematic view showing an example of a configuration of the unit 120 for accommodating the plurality of devices 90 in the internal space 150. FIG. 6 is different from the schematic view shown in FIG. 5 in that a configuration of a door for closing the subspace 151 is shown. In FIG. 6, an outer door 140 to be described below is not shown for an easy understanding of a structure of the door.

As shown in FIG. 6, in the present example embodiment, the unit 120 includes the shutter 132 as a door for closing the subspace 151. A size of a surface of the shutter 132 covering the subspace 151 can be freely changed by a length of a slat (shutter curtain) 132b drawn out from a case 132a, the slat 132b being wound in the case 132a. That is, in the present example embodiment, a configuration is realized in which the size of the surface of the door for closing the subspace 151 is variable by using the shutter 132. Each of the subspaces 151 is closed by changing the size of the surface of the door. That is, the size of the surface of the door is changed according to the set size of the subspace 151. Therefore, it is possible to appropriately close each space in which the device 90 is accommodated.

Note that the door may have a ventilation opening. In the example shown in FIG. 6, a ventilation opening 135 is provided in the shutter 132 (slat 132b). The ventilation opening 135 may be, for example, a filter having a knitted pattern. Further, the ventilation opening 135 may have a small fan. Note that the ventilation opening 135 is preferably provided on a distal end side of the shutter 132 (slat 132b) so that the ventilation opening 135 functions regardless of the size of the subspace 151. In other words, regarding the ventilation opening 135, it is preferable that the ventilation opening 135 be provided to face the subspace 151 even when the length of the slat 132b drawn out from the case 132a is short. The ventilation opening 135 contributes to appropriately maintaining a temperature environment of the subspace 151. Therefore, for example, the occurrence of malfunction of the device 90 accommodated in the subspace 151 is curbed.

In the present example embodiment, the unit 120 has the same number of shutters 132 as the number of subspaces 151. Therefore, in particular, the shelf board 130 has the shutter 132 for covering the subspace 151 immediately below the shelf board 130. Consequently, the unit 120 can include the shutters 132 corresponding to the number of subspaces 151.

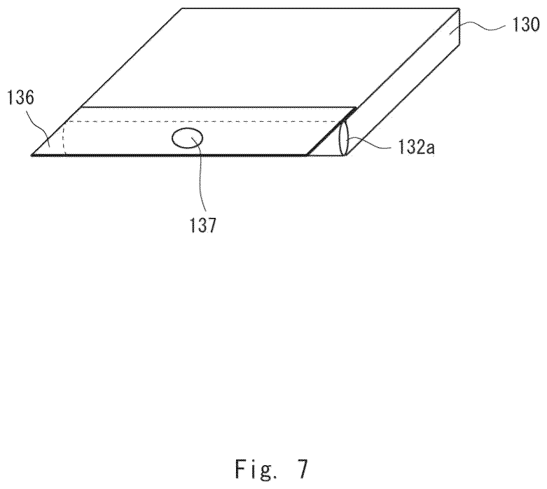

FIG. 7 is a perspective view showing a configuration example of the shelf board 130 having the shutter 132. The case 132a, in which the slat 132b is wound and accommodated, is provided on a front surface of the shelf board 130 (that is, the surface of the internal space 150 on the opening side). A stopper 136 is further provided on the front surface of the shelf board 130. The stopper 136 is, for example, a plate, and stops a distal end of a slat 132b of a shutter 132 disposed adjacent to the shutter 132 provided on the shelf board 130, that is, the shutter 132 covering the subspace 151 immediately above the shelf board 130. Therefore, as shown in FIG. 7, on the front surface of the shelf board 130, the stopper 136 is provided on an upper side thereof to stop the shutter 132 covering the subspace 151 immediately above the shelf board, and the shutter 132 is provided on a lower side thereof to cover the subspace 151 immediately below the shelf board.

Since the shutter 132 provided on the shelf board 130 is used to close the subspace 151 immediately below the shelf board 130, the uppermost subspace 151 is closed by another shutter 132. Specifically, in order to close the uppermost subspace 151, the unit 120 also has the shutter 132 at an upper portion of a front surface of the internal space 150 (a surface of the internal space 150 on an opening side).

Note that the door for closing the subspace 151 may have a lock mechanism that locks the door when the door is closed. That is, the door may have a lock mechanism that locks the door not to be opened. For example, as shown in FIGS. 6 and 7, the distal end of the slat 132b and the stopper 136 may have a lock mechanism 137 that makes the distal end and the stopper engage with each other. By providing the lock mechanism, it is possible to secure the security of the device 90 accommodated in the subspace 151. Note that the control unit 180 that controls an operation of the unit 120 related to the subspaces 151 may control an operation of the lock mechanism. In this case, for example, the control unit 180 outputs a control signal to an actuator that operates the lock mechanism. Note that the control unit 180 may perform such control in accordance with a user's instruction input via a user interface device provided at any position (for example, the unit 101 constituting the shared unit) in the multifunctional pole 100. For example, the user inputs a passcode to the user interface device and instructs unlocking, and the control unit 180 unlocks the lock mechanism in response to the unlocking instruction. Further, the control unit 180 may perform control in accordance with an instruction transmitted from an apparatus outside the multifunctional pole 100. The control unit 180 may perform control such that locking is automatically performed when a predetermined time elapses after the closing is completed. Note that the unlocking and the locking of the lock mechanism may not be performed automatically, and may be performed by a user using a physical key.

Note that the control unit 180 may control an opening/closing operation of shutter 132. In this case, for example, the control unit 180 outputs a control signal to an actuator that draws the slat 132b in and out of the case 132a. Note that the control unit 180 may perform such control in accordance with a user's instruction input via a user interface device provided at any position (for example, the unit 101 constituting the shared unit) in the multifunctional pole 100. Further, the control unit 180 may perform control in accordance with an instruction transmitted from an apparatus outside the multifunctional pole 100.

In order to set the length of the slat 132b drawn out of the case 132a to a length corresponding to the size of the subspace 151, the control unit 180 may stop a closing operation based on the position information of the shelf board 130. Here, the closing operation is an operation of drawing the slat 132b out of the case to close the subspace 151. The position of the shelf board 130 may be managed in advance, or may be detected by a sensor or the like provided in the unit 120. The size of each subspace 151 (a length of an opening in the up-down direction) is determined by the position of the shelf board 130. Therefore, the control unit 180 may determine the size of each subspace 151 based on the position information of the shelf board 130 and control the closing operation of the shutter 132 for closing each subspace 151. In this manner, the control unit 180 can stop the closing operation based on the position information of the shelf board 130, thereby automatically and appropriately closing the subspace 151.

Further, in order to set the length of the slat 132b drawn out of the case 132a to a length corresponding to the size of the subspace 151, the control unit 180 may stop the closing operation based on detection that the shutter 132 (more specifically, the distal end of the slat 132b) has reached a boundary of the subspace 151. Here, the boundary of the subspace 151 means a border portion of the adjacent subspaces 151 or an end portion of a series of subspaces 151 (a lower end of the internal space 150). In other words, the boundary of the subspace 151 means an end of the subspace 151 in the arrangement direction of the subspace 151. For example, the control unit 180 may stop the closing operation based on detection that the shutter 132 (the distal end of the slat 132b) has reached the stopper 136. Further, the unit 120 may have a sensor for detecting that the shutter 132 has reached the boundary of the subspace 151. Such control enables the subspace 151 to be automatically and appropriately closed.

In this manner, the control described above enables the subspace 151 to be automatically and appropriately closed. Therefore, convenience can be improved. However, the opening/closing operation of the shutter 132 may not be automatically performed, and may be manually performed by the user.

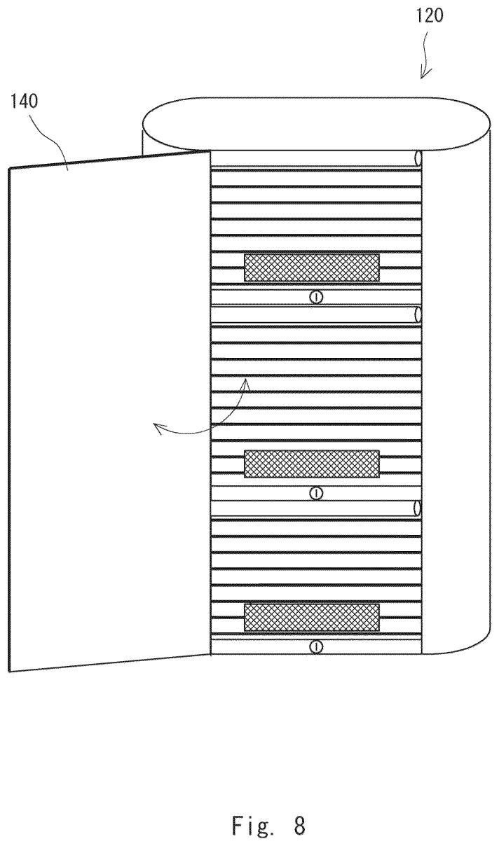

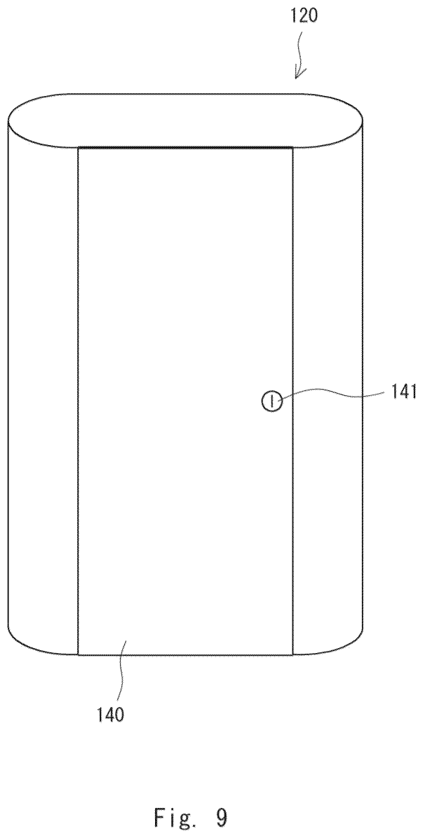

Further, the unit 120 may have an outer door that covers all of the subspaces from an outer side of the door that closes the subspaces. FIGS. 8 and 9 are schematic views showing an example of a configuration of the unit 120 for accommodating the plurality of devices 90 in the internal space 150. FIGS. 8 and 9 are different from the schematic view shown in FIG. 6 in that an outer door 140 is shown. FIG. 8 shows a state in which the outer door 140 is open, and FIG. 9 shows a state in which the outer door 140 is closed.

The outer door 140 may have a lock mechanism 141 that locks the outer door 140 when the outer door 140 is closed. That is, the outer door 140 may have the lock mechanism 141 that locks the outer door 140 not to be opened. By including the lock mechanism 141, security can be further improved. Note that the control unit 180 may control the operation of the lock mechanism 141. In this case, for example, the control unit 180 outputs a control signal to an actuator that operates the lock mechanism 141. Note that the control unit 180 may perform such control in accordance with a user's instruction input via a user interface device provided at any position (for example, the unit 101 constituting the shared unit) in the multifunctional pole 100. For example, the user inputs a passcode to the user interface device and instructs unlocking, and the control unit 180 unlocks the lock mechanism 141 in response to the unlocking instruction. Further, the control unit 180 may perform control in accordance with an instruction transmitted from an apparatus outside the multifunctional pole 100. Further, the control unit 180 may perform control such that locking is automatically performed when a predetermined time elapses after the outer door 140 is closed. Note that the unlocking and the locking of the lock mechanism 141 may not be performed automatically, and may be performed by a user using a physical key. By including the outer door 140, dustproofness, waterproofness, security, and the like of the internal space can be enhanced. Further, it is also advantageous from the viewpoint of design, when the outer door 140 is provided.

Therefore, the unit 120 preferably includes the outer door 140, but may not necessarily include the outer door 140.

The first example embodiment has been described above. As described above, at least one unit 120 constituting the multifunctional pole 100 includes the shelf boards 130 having respective positions that can be changed and the doors (shutters 132) having sizes that can be changed, and the devices 90 are accommodated in the respective subspaces 151 divided by the shelf boards 130. Therefore, the size of the subspace 151 can be changed according to the size of the device 90, and the subspace 151 is appropriately closed. Therefore, it is possible to prevent the pole from having a cluttered appearance as compared with a case where a plurality of external devices are attached to the pole, and it is possible to appropriately accommodate the devices according to the sizes of the devices. In other words, according to the above-described configuration, the pole enables devices having various sizes to be mounted therein while curbing having a cluttered appearance of the pole. Further, the multifunctional pole 100 provides a predetermined function by accommodating the device 90 having the predetermined function in the internal space 150. Therefore, there is also an advantage that introduction and maintenance of a device are easy as compared with a case where the device is integrally embedded in the pole.

Note that the multifunctional pole 100 described above is configured of, as one pole, the plurality of units 120 coupled in a row in a height direction, and at least one of the plurality of units 120 has the internal space 150. However, the pole may be configured of one structural member instead of such a plurality of units. That is, the shelf board 130 and the shutter 132 described above may be provided in the internal space of the pole made of one cylindrical structural member.

### Second Example Embodiment

Next, a second example embodiment will be described. In the first example embodiment, the shutter 132 is used as a door having a structure in which a size of a surface covering the subspace 151 is variable. In the present example embodiment, the structure in which the size of the surface covering the subspace 151 is variable is realized by another configuration. The present example embodiment is the same as the first example embodiment except for a difference in structure of a door for closing the subspace 151. Therefore, the structure of the door will be specifically described, and the description of the other configurations will be omitted as appropriate.

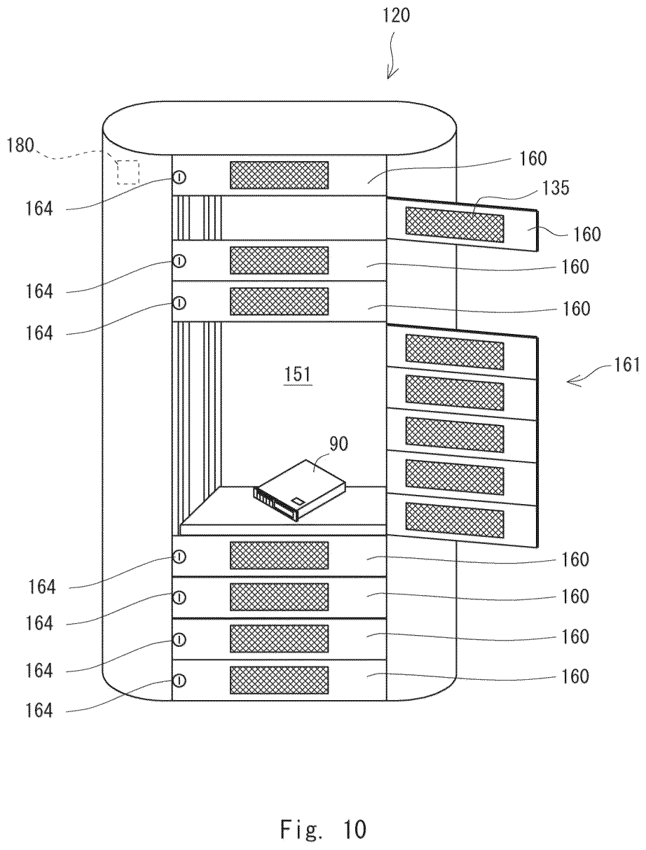

In the present example embodiment, the above-described structure is realized by using a plurality of unit doors 160 as shown in FIG. 10. FIG. 10 is a schematic view showing an example of a configuration of the unit 120 for accommodating the plurality of devices 90 in the internal space 150. Although the outer door 140 is not shown in FIG. 10 for an easy understanding of the structure of the door, the unit 120 may include the outer door 140 also in the present example embodiment. It is needless to say that, also in the present example embodiment, the unit 120 may not necessarily include the outer door 140.

As shown in FIG. 10, in the present example embodiment, the unit 120 includes the plurality of unit doors 160 as doors for closing the subspaces 151. The unit door 160 is a door that is closed for each unit space. Here, the unit space is a minimum subspace that can be set based on the position of the shelf board 130. For example, it is assumed that the shelf board 130 is disposed at any position of a plurality of predetermined positions set at predetermined intervals L in the movement direction of the shelf board 130. In this case, a subspace having a length of L in the movement direction (that is, the arrangement direction of the subspaces 151) of the shelf board 130 corresponds to the unit space. In other words, the unit door 160 is a door that closes a subspace having a minimum size. Therefore, as shown in the drawing, the plurality of unit doors 160 are arranged side by side in the arrangement direction of the subspaces 151. The unit door 160 is, for example, a single swing door as shown in FIG. 10, and may be a double swing door.

Coupling of any number of unit doors 160 arranged in a row to each other enables the plurality of coupled unit doors 160 to close the subspace 151 having any size. In other words, by changing the number of unit doors 160 to be coupled, the size of the surface covering the subspace 151 can be freely changed. For example, as shown in FIG. 10, by coupling five consecutive unit doors 160 to constitute one coupled door 161, the subspaces 151 corresponding to the five unit spaces are closed. In this manner, in the present example embodiment, a configuration is realized in which the size of the surface of the door for closing the subspace 151 is variable by using the plurality of coupled unit doors 160. In other words, in the present example embodiment, the door that closes the subspace is a door in which a number of unit doors 160 corresponding to the size of the subspace are coupled and integrated. In this manner, also in the present example embodiment, closing is performed for each subspace 151 by changing the size of the surface of the door. That is, the size of the surface of the door is changed according to the set size of the subspace. Therefore, it is possible to appropriately close each space in which the device 90 is accommodated.

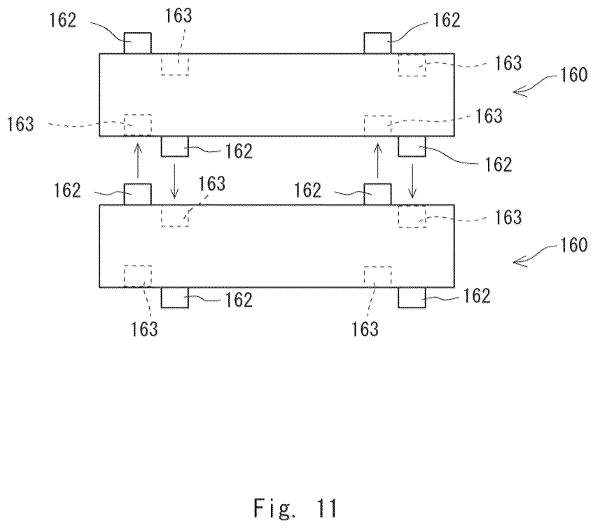

FIG. 11 is a schematic view showing an example of a configuration for realizing coupling of the unit doors 160. The unit door 160 includes a protruding member 162 (for example, a pin) that can protrude in the arrangement direction of the unit doors (that is, a direction in which the unit door is adjacent to the other unit door 160), and a hole 163 that allows the protruding member 162 of the other unit door 160 to enter. The position of the protruding member 162 changes between a state of protruding from the unit door 160 and a state of retracting into the unit door 160. In such a configuration of the unit door 160, a protruding member 162 of one unit door 160 of an adjacent unit door 160 is inserted into a hole 163 of the other unit door 160, and thereby the unit doors 160 are coupled to each other.

In the present example embodiment, the subspaces 151 are closed not by shutters 132 but by the unit doors 160. Therefore, the shelf board 130 does not need to have the shutter 132 and the stopper 136, but the shelf board 130 may have the stopper 136 in order to prevent an error in coupling such as coupling of a plurality of unit doors 160 across two adjacent subspaces 151. In other words, the stopper 136 may prevent one door (coupled door 161) configured of a plurality of coupled unit doors 160 from passing beyond the position of the shelf board 130, in other words, a range which the coupled door 161 closes from extending over two or more subspaces 151. In this case, the stopper 136 provided on the door side of the shelf board 130 stops the protruding member 162. In other words, the stopper 136 stops the protruding member 162 so that the protruding member 162 is not inserted into the hole 163. According to such a configuration, erroneous coupling can be prevented.

Note that the control unit 180 that controls the operation of the unit 120 related to the subspaces 151 may control a coupling operation of the unit doors 160. In this case, for example, the control unit 180 outputs a control signal to an actuator that operates the protruding member 162. Note that the control unit 180 may perform such control in accordance with a user's instruction input via a user interface device provided at any position (for example, the unit 101 constituting the shared unit) in the multifunctional pole 100. Further, the control unit 180 may perform control in accordance with an instruction transmitted from an apparatus outside the multifunctional pole 100. Further, the control unit 180 may control a protruding operation of the protruding member 162 based on the position information of the shelf board 130. In this case, for example, the control unit 180 performs control such that the unit doors 160 closing the respective unit spaces corresponding to the subspace 151 determined by the position of the shelf board 130 are coupled to each other. According to such a configuration, it is possible to automatically configure a door that appropriately closes the set subspace 151, and thus convenience is improved. Further, the control unit 180 may perform control such that the protruding member 162 is locked so as not to be released from the hole 163 when a predetermined time elapses after the coupling. However, the coupling of the unit doors 160 may not be automatically performed, and may be manually performed by the user.

Note that, even in the present example embodiment, the door for closing the subspace 151 may have a lock mechanism that locks the door when the door is closed. Specifically, each unit door 160 may include a lock mechanism 164 that engages with a housing constituting the internal space 150. In a case where the plurality of unit doors 160 are coupled, a lock mechanism 164 of any one of the unit doors 160 may be used. Further, an operation of the lock mechanism 164 may be controlled by the control unit 180, similarly to the other lock mechanisms described above. It is needless to say that the unlocking and the locking of the lock mechanism 164 may not be performed automatically, and may be performed by a user using a physical key. Similarly to the first example embodiment, the unit door 160 may have the ventilation opening 135.

In the above description, the unit doors 160 are coupled by the protruding members 162 such as pins, but the above-described configuration for coupling is merely an example. For example, the unit doors 160 may be coupled by other components such as screws or other configurations.

The second example embodiment has been described above. Also in the present example embodiment, at least one unit 120 constituting the multifunctional pole 100 includes the shelf boards 130 having respective positions that can be changed and the doors (unit doors 160 to be coupled) having sizes that can be changed. Then, the devices 90 are accommodated in the respective subspaces 151 divided by the shelf board 130. Therefore, the size of the subspace 151 can be changed according to the size of the device 90, and the subspace 151 is appropriately closed. Therefore, it is possible to prevent the pole from having a cluttered appearance as compared with a case where a plurality of external devices are attached to the pole, and it is possible to appropriately accommodate the devices according to the sizes of the devices. In other words, according to the above-described configuration, the pole enables devices having various sizes to be mounted therein while curbing having a cluttered appearance of the pole.

Also in the present example embodiment, the pole may be configured of one structural member (one unit). That is, the shelf board 130 and the unit doors 160 described above may be provided in the internal space of the pole made of one cylindrical structural member.

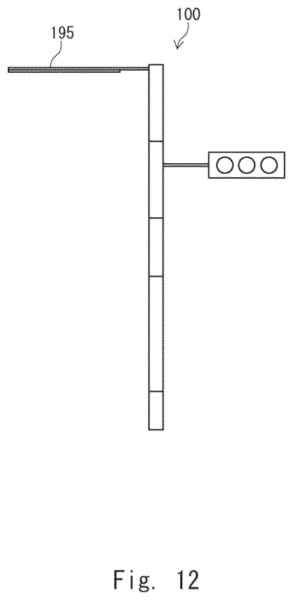

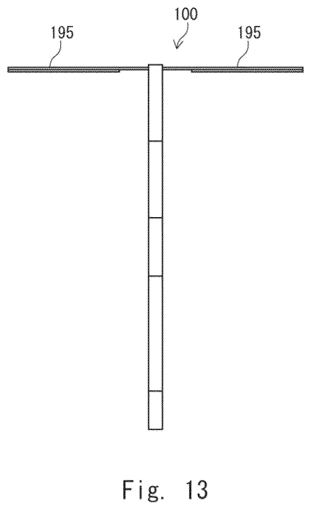

Further, in the above-described example embodiment, the multifunctional pole 100 to which the traffic signal lighting device 192 is attached from the outside has been described as an example, but the devices or the like may not be externally attached to the multifunctional pole 100. Further, as shown in FIGS. 12 and 13, any device such as an illumination lamp 195 may be attached from the outside to the multifunctional pole 100, together with the traffic signal lighting device 192 or instead of the traffic signal lighting device 192.

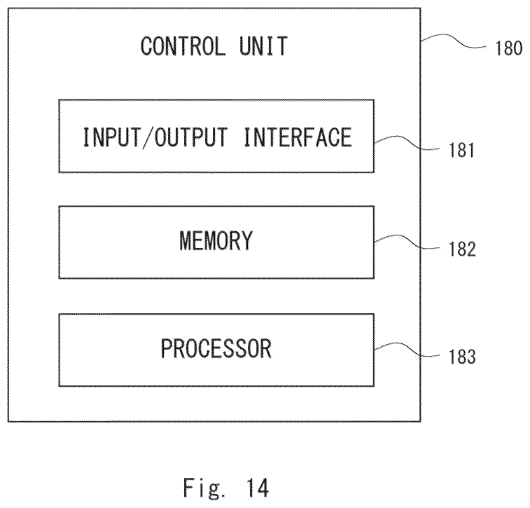

Note that the above-described various types of control may be realized by the following configurations. That is, the control unit 180 may have the following configuration. FIG. 14 is a block diagram showing an example of a configuration of the control unit 180. As shown in FIG. 14, the control unit 180 includes an input/output interface 181, a memory 182, and a processor 183.

The input/output interface 181 is an interface for communicable connection with another device as necessary.

The memory 182 includes, for example, a combination of a volatile memory and a non-volatile memory. The memory 182 is used for storing software (a computer program) including one or more instructions to be executed by the processor 183, data used for various processes, and the like.

The processor 183 reads and executes the software (the computer program) from the memory 182 to perform the above-described control process. The processor 183 may be, for example, a microprocessor, a micro processor unit (MPU), a central processing unit (CPU), or the like. The processor 183 may include a plurality of processors.

In this manner, the control unit 180 may have a function as a computer.

The program includes a group of commands (or software codes) for causing a computer to perform one or more functions that have been described in the example embodiments when the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communications medium. By way of example, and not limitation, transitory computer-readable or communication media include electrical, optical, acoustic, or other forms of propagated signals.

Although the example embodiments according to the present disclosure have been described above in detail, the present disclosure is not limited to the above-described example embodiments. The present disclosure also includes those that are obtained by making changes or modifications to the above-described example embodiments without departing from the scope and spirit of the present disclosure.

For example, the whole or part of the example embodiments disclosed above can be described as, but not limited to, the following supplementary notes.

### Supplementary Note 1

A pole including:
a shelf board configured to partition an internal space of the pole; and
a door configured to close each of subspaces partitioned by the shelf board, wherein
the door has a structure in which a size of a surface of the door is variable,
each of the subspaces has a size which is changed by changing a position of the shelf board,
each of the subspaces is closed by changing a size of a surface of the door, and
each of the subspaces accommodates a device having a predetermined function.

### Supplementary Note 2

The pole according to supplementary note 1, wherein
the shelf board has a shutter for covering one of the subspaces immediately below the shelf board, and
the door is the shutter.

### Supplementary Note 3

The pole according to supplementary note 2, wherein
the pole includes shutter control means for controlling an opening/closing operation of the shutter, and
the shutter control means stops a closing operation based on position information of the shelf board.

### Supplementary Note 4

The pole according to supplementary note 2, wherein
the pole includes shutter control means for controlling an opening/closing operation of the shutter, and
the shutter control means stops a closing operation based on detection that the shutter has reached a boundary of each of the subspaces.

### Supplementary Note 5

The pole according to supplementary note 1, including a plurality of unit doors configured to be each closed for each unit space which is a minimum settable subspace,
wherein the door configured to close each of the subspaces is a door in which a number of the unit doors corresponding to a size of a corresponding subspace are coupled.

### Supplementary Note 6

The pole according to supplementary note 5, wherein
each of the unit doors has a protruding member configured to be protrudable in an arrangement direction of the unit doors, and a hole configured to allow the protruding member of another one of the unit doors to enter, and
the protruding member of one of the unit doors is inserted into the hole of another one of the unit doors to couple the unit doors to each other.

### Supplementary Note 7

The pole according to supplementary note 6, wherein the shelf board has a stopper configured to stop the protruding member on the door side.

### Supplementary Note 8

The pole according to supplementary note 6 or 7, further including coupling control means for controlling a protruding operation of the protruding member based on position information of the shelf board.

### Supplementary Note 9

The pole according to any one of supplementary notes 1 to 8, wherein the door has a lock mechanism configured to lock the door when the door is closed.

### Supplementary Note 10

The pole according to any one of supplementary notes 1 to 9, wherein the door has a ventilation opening.

### Supplementary Note 11

The pole according to any one of supplementary notes 1 to 10, including an outer door configured to cover all the subspaces from an outer side of the door that closes each of the subspaces.

### Supplementary Note 12

The pole according to any one of supplementary notes 1 to 11, wherein the pole is configured of, as one pole, a plurality of pole units coupled in a row, and
at least one of the plurality of pole units has the internal space.

### Supplementary Note 13

A pole unit including:
a shelf board configured to partition an internal space of the pole unit; and
a door configured to close each of subspaces partitioned by the shelf board, wherein
the door has a structure in which a size of a surface of the door is variable,
each of the subspaces has a size which is changed by changing a position of the shelf board,
each of the subspaces is closed by changing a size of a surface of the door,
each of the subspaces accommodates a device having a predetermined function, and
the pole unit is coupled to another pole unit in a row to be used as one pole.

### Supplementary Note 14

The pole unit according to supplementary note 13, wherein
the shelf board has a shutter for covering one of the subspaces immediately below the shelf board, and
the door is the shutter.

### Supplementary Note 15

The pole unit according to supplementary note 13, including a plurality of unit doors configured to be each closed for each unit space which is a minimum settable subspace,
wherein the door configured to close each of the subspaces is a door in which a number of the unit doors corresponding to a size of a corresponding subspace are coupled.

### REFERENCE SIGNS LIST

1 POLE
2 INTERNAL SPACE
3 SHELF BOARD
4 SUBSPACE
5 DOOR
90 DEVICE
100 MULTIFUNCTIONAL POLE
101-109, 120 UNIT
110 SOLAR PANEL
121 FIRST CONNECTION PART
122 SECOND CONNECTION PART
123 BODY
130 SHELF BOARD
131 RAIL
132 SHUTTER
132a CASE
132b SLAT
135 VENTILATION OPENING
136 STOPPER
137 LOCK MECHANISM
140 OUTER DOOR
141 LOCK MECHANISM
150 INTERNAL SPACE
151 SUBSPACE
160 UNIT DOOR
161 COUPLING DOOR
162 PROTRUDING MEMBER
163 HOLE
164 LOCK MECHANISM
180 CONTROL UNIT
181 INPUT/OUTPUT INTERFACE
182 MEMORY
183 PROCESSOR
191 BODY
192 TRAFFIC SIGNAL LIGHTING DEVICE
193 COVER
194 ATTACHMENT TOOL
195 ILLUMINATION LAMP

What is claimed is:

1. A pole comprising:
a shelf board configured to partition an internal space of the pole; and
a door configured to close each of subspaces partitioned by the shelf board, wherein
the door has a structure in which a size of a surface of the door is variable,
each of the subspaces has a size which is changed by changing a position of the shelf board,
each of the subspaces is closed by changing a size of a surface of the door, and
each of the subspaces accommodates a device having a predetermined function.

2. The pole according to claim 1, wherein
the shelf board has a shutter for covering one of the subspaces immediately below the shelf board, and
the door is the shutter.

3. The pole according to claim 2, wherein
the pole comprises:
at least one memory storing instructions; and
at least one processor configured to execute the instructions to stop a closing operation of the shutter based on position information of the shelf board.

4. The pole according to claim 2, wherein
the pole comprises:
at least one memory storing instructions; and
at least one processor configured to execute the instructions to stop a closing operation of the shutter based on detection that the shutter has reached a boundary of each of the subspaces.

5. The pole according to claim 1, comprising a plurality of unit doors configured to be each closed for each unit space which is a minimum settable subspace,
wherein the door configured to close each of the subspaces is a door in which a number of the unit doors corresponding to a size of a corresponding subspace are coupled.

6. The pole according to claim 5, wherein
each of the unit doors has a protruding member configured to be protrudable in an arrangement direction of the unit doors, and a hole configured to allow the protruding member of another one of the unit doors to enter, and
the protruding member of one of the unit doors is inserted into the hole of another one of the unit doors to couple the unit doors to each other.

7. The pole according to claim 6, wherein the shelf board has a stopper configured to stop the protruding member on the door side.

8. The pole according to claim 6 or 7, wherein
the pole comprises:
at least one memory storing instructions; and
at least one processor configured to execute the instructions to control a protruding operation of the protruding member based on position information of the shelf board.

9. The pole according to claim 1, wherein the door has a lock mechanism configured to lock the door when the door is closed.

10. The pole according to claim 1, wherein the door has a ventilation opening.

11. The pole according to claim 1, comprising an outer door configured to cover all the subspaces from an outer side of the door that closes each of the subspaces.

12. The pole according to claim 1, wherein
the pole is configured of, as one pole, a plurality of pole units coupled in a row, and
at least one of the plurality of pole units has the internal space.

13. A pole unit comprising:
a shelf board configured to partition an internal space of the pole unit; and
a door configured to close each of subspaces partitioned by the shelf board, wherein
the door has a structure in which a size of a surface of the door is variable,
each of the subspaces has a size which is changed by changing a position of the shelf board,
each of the subspaces is closed by changing a size of a surface of the door,
each of the subspaces accommodates a device having a predetermined function, and
the pole unit is coupled to another pole unit in a row to be used as one pole.

14. The pole unit according to claim 13, wherein
the shelf board has a shutter for covering one of the subspaces immediately below the shelf board, and
the door is the shutter.

15. The pole unit according to claim 13, comprising a plurality of unit doors configured to be each closed for each unit space which is a minimum settable subspace,
wherein the door configured to close each of the subspaces is a door in which a number of the unit doors corresponding to a size of a corresponding subspace are coupled.
